(19) United States
(12) Patent Application Publication
(10) Pub. No.: US 2012/0166111 A1
(43) Pub. Date: Jun. 28, 2012

(54) PREDICTING DROPLET POPULATIONS IN PIPING FLOWS

(75) Inventors: Kyrolos Paul El Giheny, Richmond, CA (US); Eugene Valdimirovich Stepanov, Osseo, MN (US)

(73) Assignee: c/o Chevron Corporation, San Ramon, CA (US)

(21) Appl. No.: 13/331,181

(22) Filed: Dec. 20, 2011

Related U.S. Application Data
(60) Provisional application No. 61/427,508, filed on Dec. 28, 2010.

(51) Int. Cl. G06F 19/00

(52) U.S. Cl. 702/50

(57) ABSTRACT

A method to predict evolution of the diameter distribution of droplets that are injected into a process fluid in a process pipe or industrial pipeline is disclosed. The method is implemented with the use of a processor that: receives first information corresponding to a process fluid and a piping infrastructure in which the process fluid flows; receives second information corresponding to an injectant and an injector configured to inject the injectant into the process fluid; and predicts a droplet size distribution as a function of time based on the received first and second information. The prediction is based at least in part on computation of one or more closed-form expressions for mathematical description of the droplet interaction processes.

### CROSS-REFERENCE TO RELATED APPLICATIONS

This application claims benefit under 35 USC 119 of U.S. Provisional Patent Application Nos. 61/427,508 with a filing date of Dec. 28, 2010.

### TECHNICAL FIELD

This disclosure relates in general to assessment of fluid flows.

### BACKGROUND

Certain processes require the injection of certain fluids, e.g., chemicals, water, etc., dispersed in the form of droplets, into a process pipeline. Modeling of fluid flow behavior in general may be accomplished through existing software products, though often through extensive, time-consuming analysis of detailed features extensively using cumbersome numeric solutions. Such detailed analysis and computational ability may require extraordinary computer resources and a high level of skill and time.

In certain processes, it is customary to use process fluid to scrub certain gases in the equipment and/or process pipes and pipelines. For example in the oil and gas industry, water is injected into process pipes to scrub certain product gases to remove contaminants such as ammonia, hydrogen sulfide, or hydrochloric acid vapor. Undesirable by-product gases, including sour gases, may be dissolved in the scrubbing water forming what is colloquially known as “sour water” in some cases. There is a need for an improved method to model/predict fluid flow behavior in process pipes, including how contaminants are scrubbed.

### SUMMARY

In one aspect, the invention relates to a method to predict evolution of the diameter of droplets of a fluid (injectant) injected into a process fluid in a process pipe. In one embodiment, a method comprises implementing a processor that receives first information corresponding to a process fluid and a piping infrastructure in which the process fluid flows; receives second information corresponding to an injectant and an injector configured to inject the injectant into the process fluid; and predicts a droplet size distribution as a function of time based on the received first and second information, the prediction based at least in part on computation of one or more closed-form expressions for droplet interaction processes.

In another aspect, the invention relates to a system for predicting the droplet size distribution of an injectant into a process fluid in a piping infrastructure. The system comprises: a memory with logic; and a processor configured with the logic to: receive first information corresponding to both the process fluid and the piping infrastructure in which the process fluid flows; receive second information corresponding to both the injectant and an injector comprising an outlet configured to inject the injectant into the process fluid, the second information comprising an initial polydisperse distribution of droplets; and predict a droplet size distribution of the injectant as a function of distance from the outlet based on the received first and second information, the prediction based at least in part on computation of one or more closed-form expressions for droplet interaction processes.

In yet another aspect, the invention relates to a method to model the scrubbing of at least a contaminant from a process fluid that flows in a piping infrastructure with at least an aqueous scrubbing agent. The method comprises: receiving first information corresponding to the process fluid; receiving second information corresponding to the aqueous scrubbing agent; receiving third information corresponding to an injector having an outlet configured to inject the aqueous scrubbing agent into the process fluid; receiving fourth information corresponding to the piping infrastructure in which the process fluid flows; and predicting by a processor a concentration of the contaminant in the process fluid as a function of distance from the injector outlet based on the received first, second, third, and fourth information, the prediction based at least in part on computation of one or more closed-form expressions for mathematical description of droplet interaction processes and scrubbing rate.

### BRIEF DESCRIPTION OF THE DRAWINGS

The systems and methods described herein can be better understood with reference to the following drawings. The components in the drawings are not necessarily drawn to scale, emphasis instead being placed upon clearly illustrating the principles of the present disclosure. In the drawings, like reference numerals designate corresponding parts throughout the several views.

FIG. 1 is a schematic diagram of an example segment of piping and an injecting apparatus for which embodiments of droplet population modeling (DPM) systems and methods may be employed.

FIG. 2 is a block diagram of an embodiment of an example DPM system embodied as a computing device.

FIG. 3 is a screen diagram of an embodiment of an example graphical user interface (GUI) that enables the input of various parameters and activation of DPM based on the input parameters.

FIG. 4 is a screen diagram that illustrates one example output graphic provided by an embodiment of the DPM system, the output graphic illustrating the droplet diameter distribution normalized by the current droplet concentration.

FIG. 5 is a screen diagram that illustrates one example output graphic provided by an embodiment of the DPM system, the output graphic illustrating a change in the mean diameters of a droplet distribution.

FIG. 6 is a screen diagram that illustrates one example output graphic provided by an embodiment of the DPM system, the output graphic illustrating what fraction of droplets remain in a flow as a function of distance downstream of an injection point.

FIG. 7 is a screen diagram that illustrates one example output graphic provided by an embodiment of the DPM system, the output graphic illustrating what fraction of the injectant has settled as a function of distance downstream of an injection point.

FIGS. 8-10 are flow diagrams that illustrate examples of DPM method embodiments.

### DETAILED DESCRIPTION

Disclosed herein are certain embodiments of droplet population modeling (DPM) systems and methods (herein, collectively referred to also as a DPM system or DPM systems). The DPM system simulates and hence predicts how an initial polydisperse distribution of droplets of injected fluid (also referred to herein as an injectant), introduced into a carrier fluid (e.g., hydrocarbon liquid or gas, etc.), evolves as a function of the distance from an injector (e.g., spray nozzle) from where the injection occurs. In one embodiment through this simulation, assessments can be made as to a critical droplet size of the injectant. In some embodiments, assessments can be made as to the corrosion risk. For instance, droplet sizes that are largely at or below the critical size may pose a lower risk of corrosion to areas proximal to the apparatus at which the initial polydisperse distribution is injected (e.g., the injection point), whereas droplet sizes largely above the critical size may pose a greater risk of corrosion to such proximal areas.

In one embodiment, through simulations performed by embodiments of the DPM system, a quick (e.g., in some implementations, within minutes post-data entry) and accurate prediction can be made of critical droplet sizes, removing the need for expensive trial and error on important equipment. In one embodiment, one or more outputs of the DPM system can be used to form the basis of a specification of nozzle diameter size, where the specification may be communicated to one or more nozzle vendors as part of an equipment procurement strategy that reduces the risk of corrosion to the pipeline infrastructure and may improve safety.

In one embodiment, the DPM system is based on a population balance model. For instance, one set of inputs comprises an initial, polydisperse distribution of droplets (e.g., provided by a nozzle manufacturer, research facility, etc.) of the injectant at an injection point, such as a first population of droplets of size A, a second population of droplets of size B, and so on for an initial time, t₀. As the initial distribution of droplets advances randomly downstream from the injection point via the turbulent carrier fluid flow, the droplets may collide, causing fragmentation and/or coalescence, and/or droplets of certain sizes may settle out. Accordingly, at a subsequent time, t₁ (and later times t₂, t₃, etc.), the initial distribution of droplets changes (evolves). The DPM system predicts this distribution as a function of time as the injectant is carried by the turbulent flow of the carrier fluid, enabling a snapshot of the evolved distribution.

In one embodiment, the DPM system predicts how much of the injectant has settled out. For instance, it has been observed that coalescence dominates as one consequence of collisions. Accordingly, gravitational effects may pull some of the coalesced droplets from solution, which may result in misdistributions at critical areas of a piping infrastructure, such as a heat exchanger, possibly leading to impaired performance. In some embodiments, the DPM system provides a prediction of the fraction of settled water as a function of distance downstream of the injection point, facilitating system design and/or troubleshooting.

In one embodiment, the DPM system provides a prediction of the percentage of contaminants scrubbed out (e.g., removal of contaminants) of the carrier fluid embodied in a vapor phase. For instance, some acids such as HCl may be reactive with the environment, and if there is condensation present, this facilitates corrosive effects, particularly for carbon steel piping infrastructures. Remedial measures, such as the introduction of wash water or caustic substances to neutralize the corrosive effects, may benefit from knowledge about scrubbing efficiency. In some embodiments, the DPM system enables a prediction of how quickly such remedial measures take effect. In one embodiment, the system provides a prediction of changes in a scrubbing efficiency when the wash water impinges on the wall of the piping system, with the impingement occurring in an immediate vicinity of the location where the wash water is introduced. Immediate vicinity means the initial area of the pipe where the wash water is first introduced/impinges on the wall.

The employment (application) of certain embodiments of DPM systems may result in a drastically reduced time (on the order from several weeks in conventional systems to several minutes for DPM systems described herein) necessary to perform useful droplet population balance simulations in standard pipeline flow geometries, where the need to accurately evaluate the interaction between polydisperse droplets takes precedence over the need to evaluate detailed features of flow in complicated geometries (the latter of which is the focus of many existing analysis tools). For instance, in some embodiments, DPM systems restrict calculations to pipelines, which may be suitably described using a few parameters such as pipe diameter, pipe length, pipe surface roughness, and the element parameters, if present. Thus, the entire geometry for pipelines may be adequately defined in seconds or minutes via text-based inputs rather than manually drawn out, greatly reducing the time to perform simulation pre-work.

As another example, some embodiments of DPM systems use advanced analysis to evaluate the interaction between polydisperse droplets via the leveraging of closed-form equations in lieu of cumbersome numerical solutions that involve tracking separate droplets wherever possible. Existing numerical solutions require meshing (discretization) of space where droplets propagate and involve iterative “guess-and-check” as well as probabilistic methodologies to arrive at an answer. This is a bulky and unrefined process, particularly when the mesh cell size is much larger than the droplet size. Explicit closed-form expressions that are based on advanced theories of the droplet interaction in a turbulent flow furnish a viable alternative when reduction to them is appropriate (e.g., such as in standard pipeline flow geometries). Some examples where closed-form solutions may take the place of numerical evaluations include (a) kinetics of droplet collisions and coalescence, (b) kinetics of gravitational settling, and/or (c) diffusion of dispersed contaminant molecules to droplets in scrubbing calculations as well as the additional simplification that flow itself is described as an average (e.g., without spatial resolutions of the flow parameters over the pipe).

These advantages and/or features, among others, are described hereinafter in the context of a DPM system embodied as a computing device. The computing device is used in some embodiments to predict the evolution of initial droplet distributions of an injectant in a carrier fluid, and optionally predicts other effects as the droplets are carried along process piping located downstream from an injection point. It should be understood that the selection of types of injectants and/or of carrier fluids is for purposes of illustration, and that substantially any process that may benefit from a quick and accurate prediction of the evolution of the droplet size distributions from a polydisperse initial distribution similarly benefits and hence is contemplated to be within the scope of the disclosure. Further, it should be understood by one having ordinary skill in the art that, though specifics for one or more embodiments are disclosed herein, such specifics as described are not necessarily part of every embodiment.

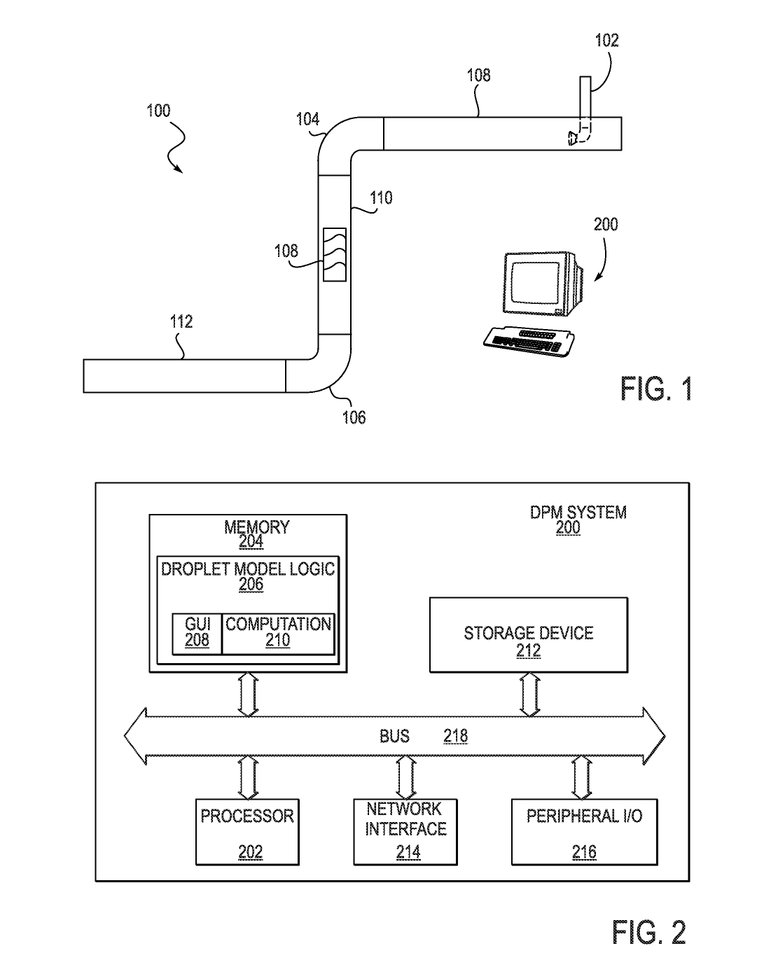

Attention is directed to FIG. 1, which is an example environment in which embodiments of droplet population modeling (DPM) systems and methods may be employed. FIG. 1 comprises a segment of a piping infrastructure 100, including an injector 102 (e.g., a spray nozzle shown partially in phantom) from which an injectant is introduced into a carrier fluid flowing through the segment 100. The segment 100 also comprises plural hydraulic elements, including elbows 104 and 106, and a static mixer 108 (shown in phantom). For instance, the injectant is introduced into the carrier fluid at the outlet of the injector 102 (coincident with the injection point). The injectant comprises an initial, polydisperse distribution of droplets, and as the injectant is carried along a horizontal pipe section 109 over time, the initial distribution evolves. The carrier fluid and the injectant travel downstream from the injector 102 through the elbow 104, along a vertical pipe section 110 that includes the static mixer 108, through the elbow 106, and along another horizontal pipe section 112. Though the static mixer 108 may act to influence turbulence exclusively, the elbows 104 and 106 may modify turbulence and induce settling. It should be understood that the segment 100 is merely illustrative, and other configurations of a piping infrastructure are contemplated to be within the scope of the disclosure.

A droplet population modeling (DPM) system 200 is used to simulate the distribution of droplets downstream from the injection point based on the initial distribution. The DPM system 200 distinguishes between the vertical pipe section 110 and the horizontal pipe sections 109 and 112. Further, the DPM system 200 may be configured to take into account the influence of gravity, and the impact that hydraulic elements have on the droplet distribution and settling. The DPM system 200 also may be configured to integrate scrubbing efficiency over a range of calculated droplet distributions, and computes how much scrubbing has occurred at any point downstream of the injection point.

FIG. 2 is a block diagram of one example embodiment of a DPM system 200 embodied as a computing device. The DPM system 200 may be embodied with fewer or some different components, such as limited in some embodiments to the logic (e.g., software code) stored in memory and a processor that executes the logic in some embodiments, or limited in some embodiments to the software logic encoded on a computer readable medium in some embodiments. In some embodiments, the DPM system 200 may encompass the entire computing device and additional components. The DPM system 200 contains a number of components that are well-known in the computer arts, including a processor 202, memory 204, a network interface 214, and a peripheral I/O interface 216. In some embodiments, the network interface 214 enables communications over a local area network (LAN) or a wide area network (WAN). In some embodiments, the network interface 214 enables communication over a radio frequency (RF) and/or optical fiber network. The peripheral I/O interface 216 provides for input and output signals, for example, user inputs from a mouse or a keyboard (e.g., to enter data into a graphical user interface), and outputs for connections to a printer or a display device (e.g., computer monitor). The DPM system 200 further comprises a storage device 212 (e.g., non-volatile memory or a disk drive). For instance, the storage device 212 may comprise historical data from prior computations or nozzle spray droplet distributions for one or more nozzle manufacturers. The aforementioned components are coupled via one or more busses 218. Omitted from FIG. 2 are a number of conventional components that are unnecessary to explain the operation of the DPM system 200.

In one embodiment, the DPM system 200 comprises software and/or firmware (e.g., executable instructions) encoded on a tangible (e.g., non-transitory) computer readable medium such as memory 204 or the storage device medium (e.g., CD, DVD, among others) and executed by the processor 202. For instance, in one embodiment, the software (e.g., software logic or simply logic) includes droplet model logic 206, which includes graphical user interface (GUI) logic 208 and computation logic 210. In one embodiment, the computation logic 210 comprises executable code embedded with one or more algorithms to perform computations and predictions on evolving droplet distributions, settling, scrubbing, etc. Further description of the various functionality of the computation logic 210 is described below in association with the different output graphics. The GUI logic 208 provides for the display of a GUI that enables the receipt of user information, and/or generates output graphics (or simply, graphics or visualizations) responsive to computations performed by the computation logic 210. In one embodiment, the GUI logic 306 is EXCEL-based. The computer readable medium may include technology based on electronic, magnetic, optical, electromagnetic, infrared, or semiconductor.

In some embodiments, functionality associated with one or more of the various components of the DPM system 200 may be implemented in hardware logic. Hardware implementations include, but are not limited to, a programmable logic device (PLD), a programmable gate array (PGA), a field programmable gate array (FPGA), an application-specific integrated circuit (ASIC), a system on chip (SoC), and a system in package (SiP). In some embodiments, functionality associated with one or more of the various components of the DPM system 200 may be implemented as a combination of hardware logic and processor-executable instructions (software and/or firmware logic). It should be understood by one having ordinary skill in the art, in the context of the present disclosure, that in some embodiments, one or more components of the DPM system 200 may be distributed among several devices, co-located or located remote from each other.

The computation logic 210 is responsible for predicting the evolution of droplet distributions over time as well as the kinetics of settling and scrubbing. A brief description of this functionality and underlying methodology follows below. With regard to distributions, the computation logic 210 bases the computations on an initial droplet distribution. Because polydispersity is often large, droplets are distributed over a range of sizes or volumes that spans several orders of magnitude. Two kinds of known distribution functions are considered by the computation logic 210. In one embodiment with different input parameters, different GUIs are generated for each of them (e.g., in an EXCEL implementation, an EXCEL workbook contains two worksheets). The first one is a log-normal distribution:

$${f}_{n}^{LN} ( {d}_{d} ) = \frac{1}{{d}_{d} σ \sqrt{2 π}} exp [ - \frac{{( ln {d}_{d} - ln \overline{d} )}^{2}}{2 {σ}^{2}} ] \qquad ( Eq . 1 )$$

that contains two parameters, d̅ and σ. Average droplet diameters “d_{d}” that are usually provided by an injection nozzle manufacturer are expressed through these parameters as:

$${d}_{10} = exp ( ln \overline{d} + \frac{1}{2} {σ}^{2} ) \\ {d}_{32} = exp ( ln \overline{d} + \frac{5}{2} {σ}^{2} ) . \qquad ( Eq . 2 )$$

The computation logic 210 takes d₁₀ and d₃₂ as input, then calculates ln d̅ and σ by equations (Eq.2) and constructs the distribution (Eq.1).

The second distribution function is a generalized power-exponential distribution that covers the types that are usually referred as Rosin-Rammler, shifted Rosin-Rammler and Nukiyama-Tanasawa distributions:

$${f}_{d}^{PE} ( {d}_{d} ) = \frac{1}{s} \frac{n}{Γ ( \frac{1 + m}{n} )} {( \frac{{d}_{d} - {s}_{i}}{s} )}^{m} Exp [ - {( \frac{{d}_{d} - {s}_{i}}{s} )}^{n} ] \qquad ( Eq . 3 )$$

where Γ(x) is the gamma function that serves the normalization of the distribution. The distribution (Eq.3) contains four parameters: m, n, s, and sᵢ. A Rosin-Rammler function appears if m=n−1; for this case, Γ(1)=1. The average diameters are expressed by equations:

$${d}_{10} = ( {s}_{i} Γ ( \frac{m + 1}{n} ) + s ( \frac{m + 2}{n} ) ) / Γ ( \frac{m + 1}{n} ) \\ {d}_{20}^{2} = ( \begin{matrix}{s}_{i}^{2} Γ ( \frac{m + 1}{n} ) + 2 {ss}_{i} ( \frac{m + 2}{n} ) + \\ {s}^{2} Γ ( \frac{m + 3}{n} )\end{matrix} ) / Γ ( \frac{m + 1}{n} ) \\ {d}_{30}^{3} = ( \begin{matrix}{s}_{i}^{3} Γ ( \frac{m + 1}{n} ) = 3 {ss}_{i}^{2} ( \frac{m + 2}{n} ) + \\ 3 {s}^{2} {s}_{i} Γ ( \frac{m + 3}{n} ) + {s}^{3} Γ ( \frac{m + 4}{n} )\end{matrix} ) / Γ ( \frac{m + 1}{n} ) \\ {d}_{32} = {d}_{30}^{3} / {d}_{20}^{2} \qquad ( Eq . 4 )$$

This distribution is convenient for fitting raw data on the droplet size distributions obtained by experimental measurements. For the data fitting, a separate GUI (e.g., EXCEL workbook) may be used. Because the average diameters are usually furnished with the raw data, equations (Eq.4) facilitate the fitting process, which is reduced in the computations to a two-parameter fitting.

In a suspension (emulsion) of water droplets injected into a turbulent flow, the size of the droplets can vary broadly. Coalescence changes the distribution over sizes with time, which decreases the total number of droplets. One underlying basis of the computation logic 210 for the droplet distribution computations may be found in the following integro-differential equation:

$$\frac{\partial n ( {V}_{d} , t )}{\partial t} = \frac{1}{2} {{\int }_{0}}^{{V}_{d}} K ( {V}_{d}^{′} , {V}_{d} - {V}_{d}^{′} ) n ( {V}_{d}^{′} , t ) n ( {V}_{d} - {V}_{d}^{′} , t ) d {V}_{d}^{′} - n ( {V}_{d} , t ) {{\int }_{0}}^{∞} K ( {V}_{d} , {V}_{d}^{′} ) n ( {V}_{d}^{′} , t ) d {V}_{d}^{′} \qquad ( Eq . 5 )$$

where n(V_{d},t) is the time-dependent concentration of droplets that have volume V_{d}. The first term in the right side of this equation is a “birth” term that is responsible for an increase in the number of droplets of the volume V_{d} as a result of the coalescence of droplets with volumes V_{d}′ and V_{d}−V_{d}′. The second, “death” term describes a decrease in the concentration because of the coalescence of those droplets with any other droplets. Viewed differently, it may be considered that droplets “populate” states that are different by the droplet volume, and coalescence changes the state population numbers. The factor ½ in the first term takes into account that a pair of droplets with volumes V_{d}′ and V_{d}−V_{d}′ and the pair with volumes V_{d}−V_{d}′ and V_{d}′ is the same pair and should not be counted twice. A kernel in this equation K(V₁,V₂) represents the frequency of coalescence between droplets of the volumes V₁ and V₂ (e.g., a kinetic constant of this process, which is a function of sizes and other parameters of the colliding droplets and is dependent upon the level of turbulence in the flow). The kernel satisfies an obvious symmetry condition:

K(V₁,V₂)=K(V₂,V₁)

because it is independent of the order in which the colliding droplets are counted. Since the injected fluid is finely fragmented into droplets in the nozzle of an injecting device, terms in the population balance equation (Eq.5) that account for a possibility of fragmentation in the turbulent flow are not necessary.

To solve numerically, equation (Eq.5) is discretized by introducing fractions with different volumes V_{d}. Upon discretization, the equation is transformed into a large chain of inter-connected equations for every fraction, the right sides of which are evaluated at each timestep to determine time increments and the evolution of the droplet distribution. Initial conditions for these equations are given by an initial distribution of droplets over fractions. Discretization is chosen in a manner that preserves volume upon coalescence (e.g., discretization on a linear volume scale).

For instance, the discretization may be performed by choosing an elementary volume increment δv that also serves as a minimum possible droplet volume in the distribution. Droplets of each fraction are considered to contain an integer number of the minimum droplet volumes, and an act of coalescence is described by an addition of integers that preserves the volume. The number of fractions to process by the computation logic 210 is affected by the choice of the elementary volume increment δv, which should be defined differently for the two kinds of initial droplet distributions under consideration. Choice of the elementary volume increment δv is determined based on a compromise between a smaller increment that results in a better resolution but increases the number of fractions and, consequently, the time of computations, and a larger increment that speeds processing at the expense of resolution. In one embodiment to model the actual polydispersity of injected droplets, around 70 billion fractions are operated upon by the computational logic 210 to describe the evolution of the droplet distribution.

By introducing fractions, equation (Eq.5) is convenient to write in terms of dimensionless fractional concentrations c(i,t), or the fractional populations, which are numerated by integers i as defined by the volume of droplets that populate them:

$$c ( i , t ) = \frac{n ( {V}_{d} , t )}{{n}_{0}} ; {V}_{d} ( i ) = i \cdot δ v \qquad ( Eq . 6 )$$

where n₀ is the initial total droplet concentration in the flow. In some embodiments, the computation logic 210 re-normalizes the initial distribution after the discretization with actual fractional populations. Accordingly, the discretized version of equation (Eq.5) comprises a chain of equations for each fraction:

$$\frac{\partial c ( i , t )}{\partial t} = \frac{1}{2} {\sum }_{j = 1}^{i - 1} K ( j , i - j ) c ( j , t ) c ( i - j , t ) - c ( i , t ) {\sum }_{j = 1}^{max} K ( i , j ) c ( j , t ) \qquad ( Eq . 7 )$$

where max corresponds to the maximum fraction number and the kernel K is modified to include the initial total droplet concentration n₀:

K(i,j)=n₀K(V_{d}(i),V_{d}(j)) (Eq.8)

The computation logic 210 solves the discretized version of equation (Eq.5) for all fractions by timesteps, and a variety of Runge-Kutta numerical techniques may be utilized. The initial distribution provides input data for the first timestep. The right side of the equation determines the population increments. As the fractional populations have been modified by the increments, they serve as input data for the next timestep.

In some embodiments, given the extent of processing cycles, known grid techniques may be employed to reduce computational complexity. In general, the grid is based on integers that quantify the fractions yet preserves the volume at every instance of coalescence. Further, since the droplet distribution over the fractions may spread over several orders of magnitude, the grid is non-uniform while providing a sufficient resolution if the droplet population evolves dramatically. In one embodiment, the computation logic 210 employs a quasi-logarithmic grid G(i) on integers, where up to the fraction number sixty-four (64), the grid contains every integer, and after sixty-four (64), the grid generates thirty-two (32) points evenly distributed on a linear scale for every power of two (2) that follows sixty-four (64) by a recursive procedure. In other words, thirty-two (32) points are generated between sixty-four (64) and one hundred, twenty-eight (128), thirty-two (32) points between one hundred, twenty-eight (128) and two hundred, fifty-six (256), and so on. Note that in some embodiments, other grid choices may be utilized with the same or different resolutions.

In some embodiments, a secondary grid G₁(i) may be employed to address computations corresponding to the birth term in equation (Eq.7) that falls outside of the grid. For instance, the secondary grid G₁(i) is parallel to the primary grid G(i) but distanced from G(i) by unity: G₁(i)=G(i)+1. For instance, the sets G₁(i) and G(i) intersect only if i<64, but for higher numbers G₁(i)≠ G(i+1). The summation in the discretized version of the birth term starts from a grid point that belongs to G(i) and all operations in the right side of the equation (Eq.7) are performed on the primary grid. As the increments are calculated, the new population distribution is defined on the secondary grid G₁(i), and only then is converted by quadratic interpolation to the primary grid. In the next timestep, the data are available on the primary grid, and the data transition G(i)→G₁(i)→G(i) is repeated again.

Having described various methods employed by the computation logic 210 to predict the droplet distribution over distance (or time) from an initial distribution, attention is directed to gravitational settling and its association with the evolving droplet distribution (based on coalescence, and hereinafter, a coalescence model) modeling described above. In general, gravitational settling of a droplet suspension may occur in horizontal parts of a pipeline and may cause significant loss in the droplet concentration. Settling is opposed by diffusion of droplets in turbulent flow that tends to homogenize the suspension. Settling in a horizontal pipe induces a gradient in the droplet concentrations in a vertical direction. The DPM system 200 couples a settling model with the coalescence model based on the assumption that the effect of this gradient on the average rate of coalescence is small so that it is still mostly determined by the averaged concentrations. This assumption is reasonable in a case when the characteristic rate of coalescence is faster than the settling rate or they are in the same order of magnitude. In the opposite case when settling is much faster than coalescence, the coupling between models is not important because settling alone predominantly defines the loss of the droplet populations. In this approximation, the DPM system 200 achieves such a coupling by considering the fractional population gains and losses because of coalescence as spatially averaged over a pipe cross-section and included as time-dependent source terms into droplet diffusion equations with gravitational drift. The droplet concentrations obtained by a solution of such equations with the source term are averaged over the pipe cross-section and re-entered into the coalescence model. The aforementioned procedure is repeated by timesteps.

In particular, a diffusion equation with gravitational drift in a rectangular horizontal duct may be written as:

$$\frac{\partial c ( i , x , t )}{\partial t} = {D}_{i} \frac{{\partial }^{2} c ( i , x , t )}{\partial {x}^{2}} + {v}_{t , i} \frac{\partial c ( i , x , t )}{\partial x} \qquad ( Eq . 9 )$$

where Dᵢ is the diffusion coefficient of the droplets of a fraction i, v_{t,i} is the appropriate droplet terminal velocity, and x is a vertical coordinate. A standard assumption is made that falling droplets quickly achieve the terminal velocity and further drift downwards with this velocity to settle. If a pipe is characterized as a duct of the same cross-sectional area, boundary conditions for this equation consist of a condition that the flux of droplets is zero at the top wall of the duct (as well as at the side walls), and of a condition that the droplets disappear from the flow at the bottom of the duct where they merge the layer of the settled water. An initial condition corresponds to a uniform distribution of droplets as they enter a horizontal part of a pipeline where settling starts. The sought functions c(i,x,t) are fractional populations that now are dependent upon the vertical coordinate.

The diffusion coefficients Dᵢ and terminal velocities v_{t,i} are individual for each fraction i, and equation (Eq.9) is actually a chain of equations for all fractional populations that settle independently of each other. As has been discussed above, coupling of coalescence and settling models can be achieved by adding a time-dependent source term into the diffusion equation with gravitational drift, which forms an equation:

$$\begin{matrix}\frac{\partial c ( i , x , t )}{\partial t} = {D}_{i} \frac{{\partial }^{2} c ( i , x , t )}{\partial {x}^{2}} + {v}_{t , i} \frac{\partial c ( i , x , t )}{\partial x} + {R}_{i} ( t ) \\ where & ( Eq . 10 ) \\ {R}_{i} ( t ) = {( \frac{\partial c ( i , t )}{\partial t} )}_{coal} & ( Eq . 11 )\end{matrix}$$

is a coalescence term that corresponds to equation (Eq.5) or to equation (Eq.7) in the discretized form. This term is determined by the averaged fractional populations c(i,t) and connects the kinetics of settling of different droplet fractions. The dependence of the source term upon the fractional populations is implicit, and the equation (Eq.10) can be rigorously solved by considering only one explicit dependence of the term Rᵢ(t), which is the dependence on time.

Taking into account the boundary and initial distribution constraints, equation (Eq.9) represents a Sturm-Liouville problem that can be solved analytically by a standard mathematical technique of finding orthogonal eigenfunctions of the problem and then expanding the solution into a series over the functional basis. This procedure results in the following equations for the averaged fractional populations:

$$c ( i , t ) = {\sum }_{k = 1}^{∞} {λ}_{ik} exp ( - {ω}_{ik} t ) [ c ( i , 0 ) + {{\int }_{0}}^{t} {R}_{i} ( {t}^{′} ) exp ( {ω}_{ik} {t}^{′} ) d {t}^{′} ] \qquad ( Eq . 12 )$$

where c(i,0) is the initial population upon the entrance in the settling zone,

$$\begin{matrix}{ω}_{ik} = ( \frac{{μ}_{ik}^{2}}{{a}_{i}^{2}} + 1 ) \frac{{v}_{t , i}^{2}}{4 {D}_{i}} & ( Eq . 13 ) \\ {λ}_{ik} = 2 \frac{{μ}_{ik}^{2}}{( {a}_{i}^{2} + {μ}_{ik}^{2} )} \frac{( 1 - 2 {e}^{{a}_{i}} cos {μ}_{ik} )}{( {a}_{i} ( {a}_{i} + 1 ) + {μ}_{ik}^{2} )} & ( Eq . 14 )\end{matrix}$$

μᵢₖ are roots of equation tan

$${μ}_{ik} = - \frac{{μ}_{ik}}{{a}_{i}} \qquad ( Eq . 15 )$$

and parameter

$${a}_{i} = \frac{{v}_{t , i} h}{2 {D}_{i}} \qquad ( Eq . 16 )$$

characterizes the rate of droplet settling in comparison to the rate of their spatial homogenization by diffusion (h is the height of the duct).

This analytical solution forms a foundation for the numerical algorithm of the settling model that is embedded into the computational logic 210. The chain of equations (Eq.12) can be solved by timesteps together with the coupled equation (Eq.7) for each fraction. However, accurate numerical summation of series (Eq.12) in the given explicit form is impossible (or nearly impossible) for all fractions over the entire computational grid because of considerable variations of parameter aᵢ that may take magnitudes aᵢ>>1 for fractions of droplets with sufficiently large diameter. In this case, the exponential term in the coefficients (Eq.14) makes the series (Eq.12) sign-alternating with large amplitude. Since the precision of large numbers can be limited by the computer processing possibilities, the accurate summation of the series is inherently hampered.

A resolution of this problem can be achieved by a mathematical analysis of the asymptotic form of the series for aᵢ>>1. An appropriate application of the methods of complex variables allows one to perform exact analytical summation of the asymptotic series, to develop an explicit substitution function that replaces the direct numerical summation at aᵢ>>1, and to define criteria at which such replacement meets the precision requirements. The developed functional substitution is critical to make the computational logic 210 operational for the accurate evaluation of series (Eq.12) regardless of the values of D and v_{t,i} as well as of the scope of the computational grid.

Achieving numerical solutions of the population balance equations requires knowledge about the coefficients in the equations, i.e. about the droplet transport coefficients Dᵢ and v_{t,i}, and about the droplet coalescence kernel K(V_{d},(i), V_{d}(j)), where i and j are the fraction numbers. These coefficients are different for each fraction and thereby represent functional dependencies on the droplet sizes, on physical properties of both injected fluid and carrier fluid, and on parameters of turbulence in the flow. Establishing such dependencies can be made by either experimental or theoretical means, or by a combination of both. The computational logic 210 allows for accommodating any functional dependencies for these coefficients. In a particular implementation, the coefficients are evaluated theoretically by the following methods.

The droplet terminal velocities vₜ for each fraction can be computed by direct solution of an implicit equation that balances gravity and the fluid resistance forces that act upon a droplet:

$$Δ ρ \cdot {gV}_{d} = {C}_{D} ( {Re}_{d} ) \frac{ρ {v}_{d}^{2}}{2} {A}_{d} \qquad ( Eq . 17 )$$

where Δρ is the density difference between the droplet and the carrier fluid, g is the gravity acceleration, V_{d} is the droplet volume, A_{d} is the droplet cross-sectional area in the direction of the droplet velocity, and C_{D} is the drag coefficient that depends upon the droplet Reynolds number Re_{d}. In the solution of equation (Eq.17), its value corresponds to the terminal velocity:

$${Re}_{d} = \frac{{v}_{t} {d}_{d}}{υ} \qquad ( Eq . 18 )$$

where d_{d} is the droplet diameter and v is the kinematic viscosity of the carrier fluid. By presenting the drag coefficient in a form:

$${C}_{D} ( {Re}_{d} ) = \frac{24}{{Re}_{d}} ϕ ( {Re}_{d} )$$

and by taking into account that the ratio V_{d}/A_{d}=(2/3)d_{d} for spherical droplets, equation (Eq.17) reduces to the following:

$$\frac{Δ ρ}{ρ} \cdot \frac{{gd}_{d}^{3}}{18 {v}^{2}} = {Re}_{d} ϕ ( {Re}_{d} ) \qquad ( Eq . 19 )$$

The function φ(Re_{d}) represents non-linear corrections to the drag coefficient C_{D}, for which a smooth function of a recently developed Brown-Lawler approximation is utilized:

$$ϕ ( {Re}_{d} ) = 1 + 0.15 \cdot {Re}_{d}^{0.681} + \frac{{Re}_{d}}{24} \frac{0.407}{1 + 8710 \cdot {Re}_{d}^{- 1}} \qquad ( Eq . 20 )$$

This approximation is valid while Re_{d}≦2·10⁵, which is a sufficiently broad range for the injection conditions under consideration.

Assessment of the droplet diffusion coefficient D, as well as of the coalescence kernel, is made by incorporating the modern results of the advanced theories of turbulent transport, available in the current literature. Establishing theoretical correlations between diffusion coefficient of particles in a turbulent flow and the parameters of turbulence has a long history. A fundamental difference exists between a short-term diffusion coefficient and a long-term diffusion coefficient, particularly under conditions of drift, which is important for settling. The short-term diffusion coefficient controls initial dispersion of particles and the collision frequency and is determined by a degree of particle involvement into the turbulent fluid motion. The short-term dispersion kinetics is non-linear, and is defined by turbulent eddies whose time scale is less than the time of dispersion, and an effective diffusion coefficient increases with time. In long-term diffusion, a particle has sufficient time to interact with the entire spectrum of eddies, and it is known that the appropriate diffusion coefficient is first derived to be equal to the diffusion coefficient of fluid particles (e.g., to the eddy diffusivity). As a fluid particle, an elementary volume of fluid that is much smaller than the size of smallest turbulent eddies but larger than a molecular scale is assumed.

Further theoretical investigation of this problem by several sources has revealed that the long-term particle diffusion coefficient is not exactly equal to the eddy diffusivity. The difference occurs because of three major effects. Since the particle response to the interaction with turbulent eddies proceeds during a finite time, inertial particles move slower along trajectories than fluid particles would move. This is called as an inertial effect. The second effect appears when particle drifts and its velocity can exceed the amplitude of the eddy velocity fluctuations, so that the particle can move between eddies faster than a fluid particle. This phenomenon is referred to as a crossing-trajectory effect. The crossing-trajectory effect is anisotropic relative to the drift direction, which makes the coefficient of diffusion in a longitudinal direction different from that in a transverse direction. The fact of the anisotropy constitutes the third effect that is also known as a continuity effect.

There is no general equation for calculation of the particle diffusion coefficient as a tensor that takes into account all three effects, and is valid for any particles or droplets in a turbulent flow at any conditions. In a particular implementation, the computation logic 210 uses results of a known comprehensive model that has been developed recently in the literature for the evaluation of the diffusion coefficient of arbitrary-density particles that diffuse and settle at the conditions of isotropic turbulence. The model takes advantage of the structural properties of isotropic turbulence and deals mainly with large-scale velocity fluctuations as they affect the particle motion, which is most appropriate to a long-term diffusion. The utilized model is capable of providing explicit functional equations for the tensor components of the diffusion coefficient in the longitudinal and transversal directions relative to the gravitational drift. The model equations operate with the drift parameter:

$$γ = \frac{\vert {v}_{t} \vert}{u} \qquad ( Eq . 21 )$$

where u is the root-mean-square fluctuations of the fluid velocity components in the field of turbulence, and with the particle Stokes number:

$$St = \frac{{τ}_{r}}{{T}_{L}} \qquad ( Eq . 22 )$$

that represents a ratio of the droplet relaxation time τᵣ to a Lagrangian time scale of turbulence T_{L}. The droplet relaxation time τᵣ can be evaluated as:

$${τ}_{r} = \frac{{τ}_{r , 0}}{ϕ ( {Re}_{d} )} ; {τ}_{r , 0} = \frac{{ρ}_{d}}{ρ} \frac{{d}_{d}^{2}}{18 v} \qquad ( Eq . 23 )$$

where d_{d} is the droplet diameter, ρ_{d} is the droplet density, and the non-linear correction to the drag coefficient can be calculated by expression (Eq.20). Since the diffusion in the direction of gravitational drift solely is of interest for the above settling model, this implementation of the computational logic 210 uses only the model equation for the longitudinal component of T_{Lp}.

Assessment of the coalescence kernel K(V_{d}(i), V_{d}(j)), where i and j are the droplet fraction numbers, taps into the essence of the physics of turbulence. Coalescence of droplets dispersed in the flow is a complicated process that is determined by the interaction of the droplets with a broad spectrum of turbulent eddies. The rate of coalescence is first defined by the rate of the droplet collisions with each other. Collisions occur because of the random motion of droplets in the field of turbulence, which may be treated as the short-term diffusion of droplets toward each other. For droplets in a gaseous flow (suspensions), it may be assumed at the first approximation that every collision results in coalescence. If droplets are dispersed in a liquid flow (emulsions), the probability of coalescence per collision, the so-called coalescence efficiency, may be much less than unity. One mechanism of droplet coalescence in liquids involves drainage of a liquid film between colliding droplets, which takes a finite time, and results in a probability that colliding droplets separate before the drainage is completed. A particular implementation of the computation logic 210 is orientated mostly toward analysis of the droplet populations in a gaseous flow, and the rate of coalescence is assessed by the rate of droplet collisions, i.e. the coalescence kernel is assumed to be equal to the collision kernel. However, there are no limitations to include additional models for the coalescence probability as corrections to the collision kernel in the case of a purely liquid flow.

A variety of theories exists for evaluating the collision rate of droplets in the field of turbulence. The choice of a model for implementation into the computational logic 210 is dictated by the correct identification of the range of flow conditions, sizes, and physical properties of the injected droplets corresponding to the range of major parameters of turbulence.

Turbulence can be characterized by a broad spectrum of the velocity fluctuations that spans from large-scale eddies, the size of which is determined by the geometry of the flow, to small eddies that are responsible for the turbulent energy dissipation through viscosity. The space, time, and velocity scales of the smallest eddies are independent of the flow geometry and dimensions, and are defined by so-called Kolmogorov length l_{K}, time τ_{K}, and velocity u_{K}. These scales are defined by the physical properties of the carrier fluid and by the energy release rate in the flow. The time scale of the large-scale eddies may be defined by the Lagrangian time scale T_{L} that has been mentioned above. On the other hand, a response in the droplet motion to the carrier fluid velocity fluctuation is characterized by the relaxation time τᵣ, defined by equation (Eq.23). If the relaxation time τᵣ<<τ_{K}, the droplet is embedded in all kinds of turbulent eddies and the droplet follows the velocity fluctuations. In the far opposite case, when τᵣ is much larger than the time scale of the large eddies, τᵣ>>T_{L}, the droplet is detached from all turbulent eddies. In this case, the motion of two droplets that may collide is uncorrelated. In the intermediate case, when the droplet relaxation time is in a so-called inertial range, τ_{K}<τᵣ<T_{L}, droplets are embedded in large eddies but detached from smaller ones, and the motion of colliding droplets is partially correlated. All these cases correspond to different mathematical approaches and different models.

Analysis of the flow and the injection conditions typical for applications in the petrochemical industry shows that injected droplets mostly stay in the range of large Stokes numbers (Eq.22) with some possible fraction of the droplet population to be in the inertial range. A known model, most appropriate to this case, which combines a traditional comprehensive mathematical analysis with recent results of the direct numerical simulation studies is selected for a particular implementation into the computational logic 210. The core of the model is the correct calculation of so-called particle involvement coefficients that connect the velocity fluctuations of particles in their random walk toward each other with the fluid velocity fluctuations. A general approach for arbitrary-density particles in the inertial range of homogeneous and isotropic turbulence has been developed in the model. This has made it possible to utilize a closed-form expression for the collision kernel for a broad variety of conditions relevant to particular applications that are addressed by the computational logic 210.

Input parameters of turbulence for the assessments of the droplet diffusion coefficient and the coalescence kernel, such as u, T_{L}, and τ_{K}, may be evaluated, for example, by the standard equations and the results of the k-ε theory of turbulence or from a variety of formulas available in the literature that interpolate results of direct numerical simulations.

In some embodiments, the computation logic 210 is configured with a model to predict scrubbing of contaminants from a vapor phase. As the droplet concentration and the distribution over sizes are known, it is possible to assess the efficiency of scrubbing (washing out) contaminant species from the flow. For instance, water can collect molecular contaminants provided the contaminants have certain solubility in water. It can be also effective for microscopic solid particles, collisions with which by the same mechanism as collisions with other droplets eventually accumulate them in the water. As far as molecular contaminants are concerned, the efficiency has two components, thermodynamic and kinetic. The thermodynamic, or equilibrium component defines the maximum possible efficiency of scrubbing given species by water, and is defined by the solubility of the contaminant in water and by the volume fraction of water in the flow. By considering a carrier fluid as gas where contaminant is also gaseous, and by operating with dimensionless solubility S in units of volume/volume, a balance between the species dissolved in water and this species remained in gas at complete equilibrium leads to the following equation:

$${c}_{c , eq} = \frac{{n}_{c , eq}}{{n}_{c , 0}} = \frac{1}{1 + {α}_{V} S} \qquad ( Eq . 24 )$$

where n_{c,0} is the initial concentration of the contaminant species in the carrier fluid, n_{c,eq} is its final concentration at equilibrium, c_{c} is its dimensionless concentration, defined relatively to the initial one, and α_{V} is the volume fraction of water in the fluid. The water volume fraction is defined by a ratio between the water and fluid volumetric flow rates.

Scrubbing is considered as efficient if the final concentration of the contaminant is less than the initial one (e.g., c_{c,eq}<<1). Equation (Eq.24) shows that this requires fulfillment of a condition

α_{V}S>>1 (Eq.25)

This condition helps determine the amount of water to be injected into the flow to achieve a desirable decrease in the contaminant concentration. The amount of water also depends on the pressure and the temperature of the carrier fluid in the flow that affect the value of dimensionless solubility S. As an example of such calculations, the solubility of ammonia at atmospheric pressure is 862 vol/vol, which, by equation (Eq.24), requires the water volume fraction to be larger than 0.1% to reduce the concentration of ammonia in the gas two times.

The thermodynamic efficiency of scrubbing as has been defined by equation (Eq.24) is independent of whether water is dispersed into droplets, moves as a separate stream, or settles on the bottom of the pipe, if the volume fraction α_{V} is the same. Thermodynamics does not operate with a concept of rate (e.g., the area of kinetics). If the condition (Eq.25) is satisfied, a question remains of how fast or how long the pipe length for a given flow is needed for the contaminant concentration to achieve the equilibrium concentration c_{c,eq}. The computation logic 210 comprises a scrubbing model that addresses the concept of rate.

Until the scrubbing is close to completion, the concentration of the contaminant in water is below the equilibrium value, and the contaminant concentration in the gas is above it. Thus, it is considered in a kinetic model that the conditions are far from equilibrium in both phases. At these conditions, contaminant molecules that approach the surface immediately become dissolved as they reach it. This means that the rate of scrubbing is controlled by the transport of the species from the bulk of fluid to a droplet, e.g., determined by the diffusion rate.

In a turbulent flow, molecular diffusion, as well as molecular viscosity, is dominant only below known Kolmogorov length and time scales. The sizes of droplets under consideration at typical conditions of the hydrocarbon flow belong to the inertial range of turbulence, mentioned above. Accordingly, transport to the surface of such droplets takes place over a distance of the same order of magnitude. In this situation, the major mechanism of transport is not molecular but turbulent diffusion, similar to the transport of droplets toward each other prior to collision. The computational logic 210 is capable of implementing any analytical model of the turbulent transport into the equations of the droplet population balances in order to calculate the scrubbing rate. In one embodiment, a synthetic approach is utilized, which is based on describing the turbulent transport in terms of collisions of fluid particles that contains the contaminant with droplets in the flow.

As scrubbing proceeds, the contaminant concentrations consistently drop along the pipeline. However, it should be kept in mind that this drop is determined by purely kinetic consideration and no thermodynamic limitations are implied. As the contaminant concentration decreases, it eventually approaches the equilibrium limit of the contaminant concentration, after which the concentration does not decrease any further. This limit is specific to a molecular contaminant under consideration, and including it into the computation logic 210 requires additional input such as the dimensionless solubility S that is particular for the species and is also dependent upon both temperature and pressure in the carrier fluid. If the flow is liquid, relative solubility between the liquid and water is needed. An assessment of the equilibrium concentration of the contaminant that takes into account the entire set of the thermodynamic parameters of the fluid in the flow can be performed by separate software for thermodynamic analysis of streams.

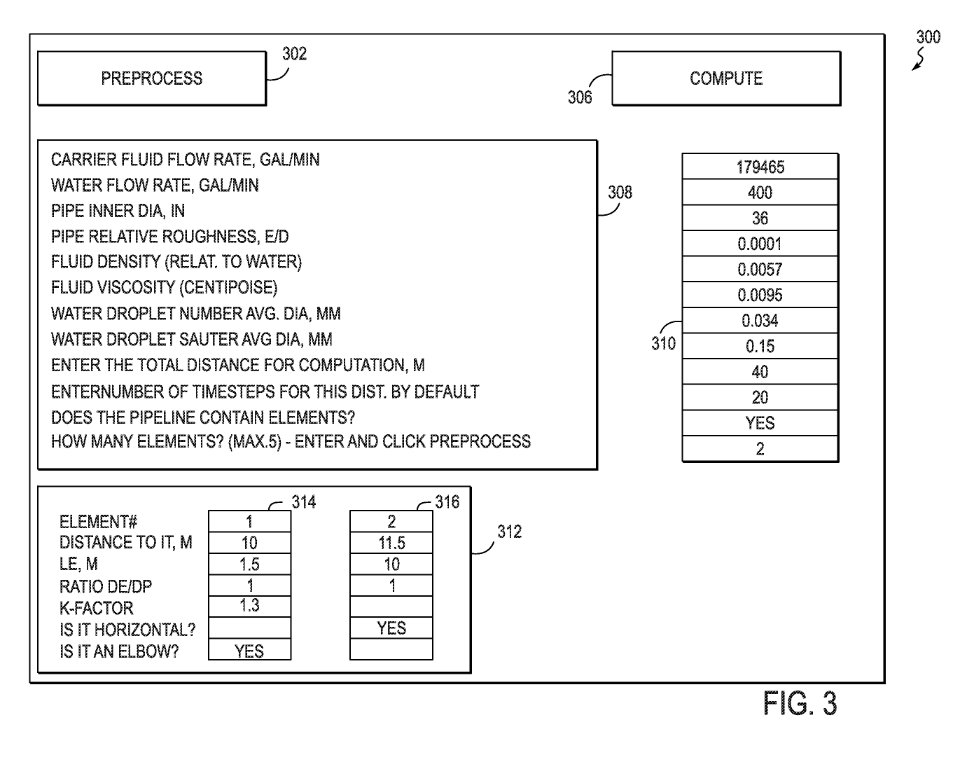

In some embodiments, the computation logic 210 is also responsible for suitable treatment of hydraulic elements (herein also simply referred to as an element or elements). In other words, the computation logic 210 allows for analyzing the evolution of the droplet population in various hydraulic elements along a pipeline by virtue of implementation of an element model. Anything that induces changes in the flow turbulence and in settling in comparison to a straight pipe of a given diameter is considered as a hydraulic element. In order to distinguish between vertical and horizontal sections of the pipe, the settling model of the computation logic 210 cooperates with the element model, and an input table of a graphics user interface (see, e.g., FIG. 3) requires identification of an element as horizontal. A typical element that modifies turbulence only is a static mixer, such as static mixer 108. Elbows (e.g., such as elbows 104 and 106) modify turbulence and also induce centrifuging droplets to the pipe wall, which is treated as settling with a centripetal acceleration of the flow.

An element is characterized by its length Lₑ, by its hydraulic diameter dₑ, and by its flow resistance coefficient Kₑ that is also known as a K-factor. The K-factor is defined in this application as a coefficient of proportionality between pressure losses across the element ΔPₑ and the dynamic pressure of the flow in the element:

$$Δ {P}_{e} = {K}_{e} \frac{ρ {U}_{e}^{2}}{2} \qquad ( Eq . 26 )$$

where ρ is the fluid density and Uₑ is the flow velocity through the element that relates to the flow velocity U through the pipe by the squared ratio of hydraulic diameters:

$${U}_{e} = {U ( \frac{{d}_{p}}{{d}_{e}} )}^{2} \qquad ( Eq . 27 )$$

The K-factors for a broad variety of elements are tabulated in known publications.

For modeling the evolution of the droplet distribution in the elements, the major parameters of the turbulent flow, such as the turbulent energy and the energy release rate, are correlated between those in a pipe and in an element. In one embodiment, this correlation is achieved by solving basic equations of the momentum and energy balances as they are considered to be averaged over the cross-section of the flow, and by taking into account the spectrum of the turbulent velocity fluctuations in a Kolmogorov form. The correlated flow parameters are thereby expressed in terms of the element characteristics, mentioned above, and are utilized for modeling the droplet interaction kinetics in the elements in the same way as has been described for the flow in a pipe. If an element is a section of the pipe of a different diameter, a standard friction coefficient for the flow in the element that is defined by the Darcy equation is used instead of the K-factor.

As far as settling in the elements is concerned, such elements as elbows represent a special case. Settling in elbows occurs under the action of centrifugal acceleration gₑ:

$${g}_{e} = \frac{{U}_{e}^{2}}{{r}_{e}} \qquad ( Eq . 28 )$$

where rₑ is the radius of curvature of the elbow central contour line. For 90° elbows, this radius is calculated by the computation logic 210 from the elbow element length as rₑ=(2/π)Lₑ. This acceleration can exceed gravity hundred times.

An analysis that uses typical droplet distributions and flow conditions in elbows has shown that terminal velocities vₜ of droplets on the large-size tail of the distribution can be formally higher than the flow velocity Uₑ in an elbow. Such velocities may never be achieved if time for droplet acceleration and the time of flight through the elbow Lₑ/Uₑ are taken intoconsideration. However, it limits the validity of the settling model that operates with constant drift velocities vₜ only to some part of the droplet distribution in elbows. To make the settling model for elbows work for any distribution without restrictions, the computation logic 210 provides a correction to the model to account for the transient velocities of s in elbows. The correction quantifies the time of the droplet acceleration and introduces an effective magnitude of the drift velocity. The effective drift velocity coincides with the terminal velocity vₜ for small droplets that reach vₜ during the time of flight, and never exceeds the flow velocity Uₑ for large droplets. In particular, the correction implemented by the computation logic 210 comprises a magnitude of an effective drift velocity that is averaged over the time of the droplet acceleration and may be considered to be constant as far as a distance passed by a droplet toward the elbow wall is concerned. Because settling of a droplet is assumed to take place when it reaches the wall, defining an effective drift velocity by the passed distance is appropriate.

The computation logic 210 implements the correction by solving equation (Eq.19) where gravity is replaced by the centrifugal acceleration and by computing the terminal velocity in the same way as for gravitational settling. Then the relaxation time is calculated in accordance with equation (Eq.23), and these two parameters are used to determine the magnitude of the effective drift velocity.

FIG. 3 is a screen diagram of an embodiment of an example graphical user interface (GUI) 300 that enables the input of various parameters and activation of the underlying functionality of the DPM system 200 based on input parameters. It should be understood that the GUI 300 shown in FIG. 3 is merely illustrative, and should not be construed as implying any limitations upon the scope of the disclosure. For instance, the GUI 300 may include fewer or additional choices, and/or a different arrangement of GUI features in a single GUI or dispersed among a plurality of GUIs. In one embodiment, the GUI 300 comprises plural button icons, including a preprocess button icon 302 and a compute button icon 306. The example GUI 300 also comprises an information description section 308, a corresponding data entry section 310, and a hydraulic element section 312 with column entry fields 314 and 316 for each identified hydraulic element (e.g., two in this example).

The information description section 308 comprises information that guides a user through entry of corresponding data in the fields of the data entry section 310. The information description section 308 comprises such information as carrier fluid flow rate (e.g., gallons per minute, gal./min.), injectant flow rate (e.g., water flow rate, in gal./min.), pipe inner diameter (e.g., inches, or in.), pipe relative roughness (e.g., e/d), fluid density relative to water, fluid viscosity (e.g., in centipoise), water droplet number average diameter (e.g., millimeters, or mm), water droplet Sauter average diameter (e.g., mm), total distance for computation (e.g., meters, m), number of timesteps for this distribution by default, whether the pipeline contains hydraulic elements, and the quantity of them. In some embodiments, additional entries may be included.

Subsequent to indicating in the section 310 that there are hydraulic elements and also indicating the quantity, a user selects the preprocess button icon 302. Responsively, the column entry fields 314 and 316 are generated in section 312 to enable the user to enter the pertinent data for each element number. For instance, the hydraulic element section 312 comprises fields associated with distance (e.g., meters) from the injection point to the hydraulic element, the element length (Lₑ, in meters), ratio dₑ/dₚ (e.g., where dₑ is the diameter of the hydraulic element and dₑ is the pipe diameter), the element K-factor, and whether the hydraulic element is located in horizontal piping and whether the hydraulic element constitutes an elbow. In one embodiment, horizontal piping is treated as a hydraulic element without a K-factor. The entry of an elbow activates simulation functionality of the DPM system 200 corresponding to settling with centrifugal acceleration as described below. Further, for elbows, Lₑ is a contour length of a center line, where the turning radius is calculated as 2 Lₑ/π.

One or more of certain constraints or underlying assumptions may be employed for certain DPM system embodiments. For instance, computations corresponding to the distance from the injection point should allow for 2-3 dₚ, for dispersion, and if the first element is in the range or closer than 2-3 dₚ, a value of zero (0) may be entered for the corresponding distance field. Further, if K-factor is not entered, the computation logic 210 may use a friction factor for a flow in the pipe of the element diameter dₑ. Additionally, if the hydraulic elements are connected in series, they may be considered as one element with their corresponding lengths and K-factors summed. In some embodiments, K-factor values may be entered (or automatically populated) based on industry standards. Note that, although illustrated in SI units (e.g., meters), it should be appreciated that some embodiments may utilize other units of measurement.

A user may select the compute button icon 306 after entering information into the various field of the GUI 300, which causes the computation logic 210 to compute droplet diameter distributions as a function of time or distance from the source (injector outlet), among other computations, and cooperate with the GUI logic 208 to provide one or more output graphics as described below.

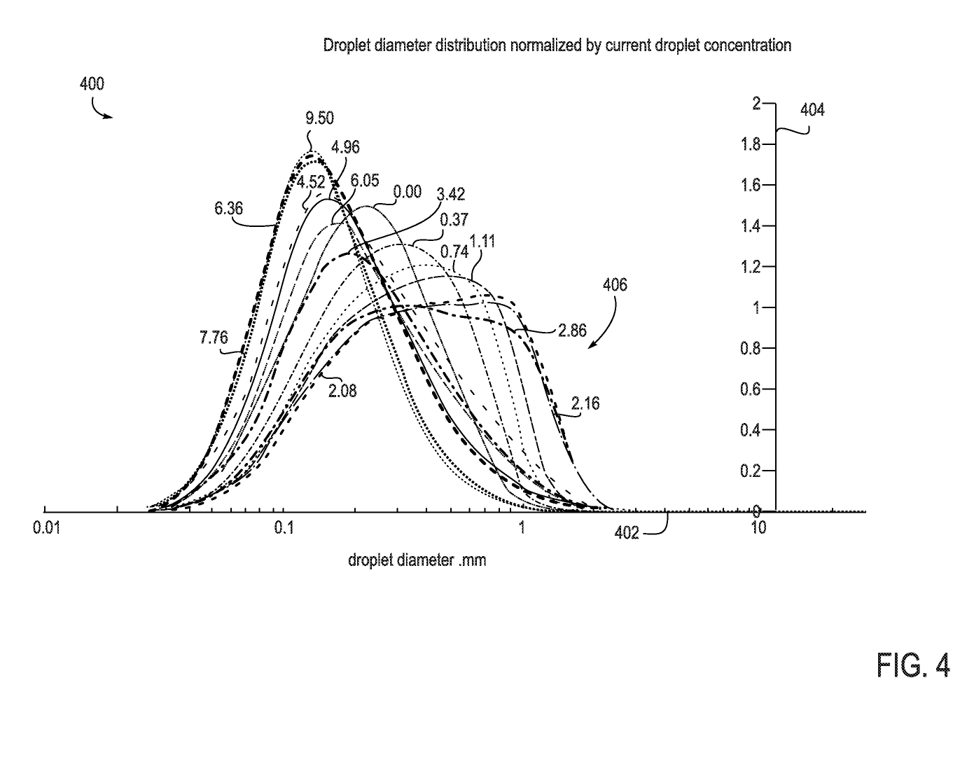

FIG. 4 illustrates one example output graphic 400 provided by an embodiment of the DPM system 200, the output graphic 400 illustrating droplet diameter distribution normalized by current droplet concentration. The output graphic 400 may be provided for display on a computer monitor or other type of display device coupled to (e.g., wirelessly or via a wired connection) or integrated into the DPM system 200. It should be understood that the output graphic 400 (as well as the other output graphics described hereinafter) is illustrated according to one example format, and that in some embodiments, a different mechanism for displaying the results of the computations performed by the computation logic 210 may be implemented (e.g., in the form of tables, bar charts, etc.). Further, for purposes of brevity, the following output graphics are described in the context of log-normal distribution functions, with the understanding that similar concepts apply to the generation of the results of computation logic 210 for power-exponential functions.

In the present example, the output graphic 400 comprises a horizontal axis 402 and a vertical axis 404. The horizontal axis 402 corresponds to a droplet diameter (e.g., in units of millimeters), and the vertical axis 404 corresponds to a distance (e.g., in meters) downstream from the source (e.g., injector outlet). It should be appreciated that in some embodiments, other units of measure and/or scales may be used. A set of curves 406 generated by the DPM system 200 illustrate the droplet diameter distributions as a function of the distance from the injection point. In other words, each curve of the set of curves 406 is a distribution of droplets at t=t₀, t₁, t₂, etc. Each curve of the set of curves 406 is displayed as a function of distance downstream of the source rather than (equivalently) as a function of time, though some embodiments may display the result as a function of time. As is evident from the output graphic 400, the quantity of different droplet sizes decreases as a function of distance from the source. The output graphic is presented responsive to the computation by the computation logic 210 of a number density distribution function, as provided by the following equation:

$${f}_{n} ( log {d}_{d} ) = 3 i \cdot c ( i , t ) \cdot ln 10 / {\sum }_{i = 1}^{max} c ( i , t ) \qquad ( Eq . 29 )$$

which in one embodiment is always normalized by unity despite the total droplet population decreasing because of coalescence or settling.

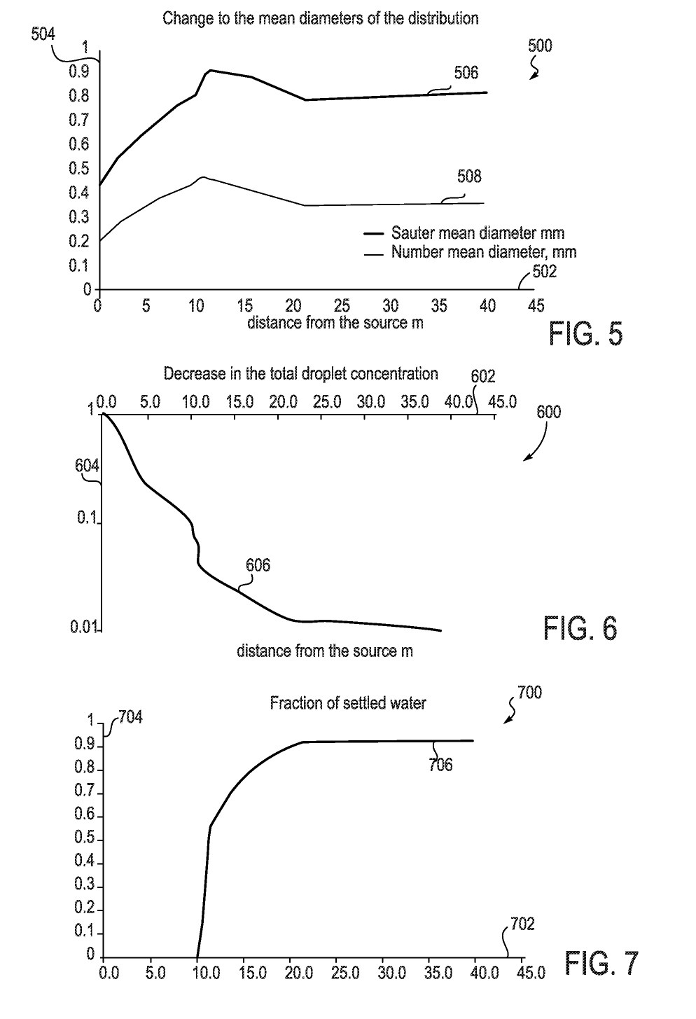

FIG. 5 illustrates an example output graphic 500 showing a change in the mean diameters of a droplet distribution, both in terms of the number mean diameter and the Sauter mean diameter as a function of distance from the source. In the present example, the output graphic 500 comprises a horizontal axis 502 and a vertical axis 504. The horizontal axis 502 corresponds to a droplet diameter (e.g., in units of millimeters), and the vertical axis 504 corresponds to a distance (e.g., in meters) downstream from the source (e.g., injector outlet). In some embodiments, other units of measure and/or scales can be used. The output graphic further comprises a Sauter mean diameter curve 506 and a number mean diameter curve 508. In one embodiment, the number average droplet diameter is calculated by the computation logic 210 according to the following equation:

$${d}_{10} = {\sum }_{i = 1}^{max} {d}_{d} ( i ) c ( i , t ) / {\sum }_{i = 1}^{max} c ( i , t ) \qquad ( Eq . 30 )$$

The Sauter mean is computed by the computation logic 210 according to the following equation:

$${d}_{32} = {\sum }_{i = 1}^{max} {d}_{d}^{3} ( i ) c ( i , t ) / {\sum }_{i = 1}^{max} {d}_{d}^{2} ( i ) c ( i , t ) \qquad ( Eq . 31 )$$

FIG. 6 is a screen diagram that illustrates one example output graphic 600 provided by an embodiment of the DPM system 200, the output graphic illustrating what fraction of droplets remain in a flow as a function of distance downstream of the source (an injection point). There is a direct correlation between the decrease in the total droplet concentration and the contaminant concentration (as a function of distance from the injection point). In the present example, the output graphic 600 comprises a horizontal axis 602 and a vertical axis 604. The horizontal axis 602 corresponds to a distance (e.g., in meters) downstream from the source (e.g., injector outlet), and the vertical axis 604 corresponds to a total droplet concentration. In some embodiments, other units of measure and/or scales may be used. The curve 606 shows a diminished fraction of droplets remaining in the flow as a function of distance, substantially leveling off in this example after about twenty-three (23) meters from the source. In short, the output graphic 600 plots the sum of all fractional populations:

$${\sum }_{i = 1}^{max} c ( i , t )$$

that shows a relative decrease in the total droplet concentration in comparison with the initial distribution.

FIG. 7 illustrates an example output graphic 700 showing what fraction of injected water has settled as a function of distance downstream of an injection point. In the example, the output graphic 700 comprises a horizontal axis 702 and a vertical axis 704. The horizontal axis 702 corresponds to a droplet diameter (e.g., in units of millimeters), and the vertical axis 704 corresponds to a distance (e.g., in meters) downstream from the source (e.g., injector outlet). In some embodiments, other units of measure and/or scales may be used. The output graphic further comprises curve 706, which plots the fraction of the total droplet volume that is lost because of settling up to a given moment of time according to the following expression:

$$1 - ( {\sum }_{i = 1}^{max} i \cdot c ( i , t ) / {\sum }_{i = 1}^{max} i \cdot c ( i , 0 ) )$$

The functions on the graph are presented versus a distance from the droplet injection source zₚ that is connected with time in the computations by taking into account all elements included in a pipeline:

$${z}_{p} = {\int }_{0}^{t} U ( t ) d t \qquad ( Eq . 32 )$$

The U(t) in equation (Eq.34) is the flow speed that can change in elements if the element hydraulic diameter dₑ is different from the pipe diameter dₚ.

Note that in some embodiments, additional and/or different output graphics may be presented to provide different perspectives, such as droplet volume distribution, rate of change in droplet populations, decrease in contaminate concentrations, among others.

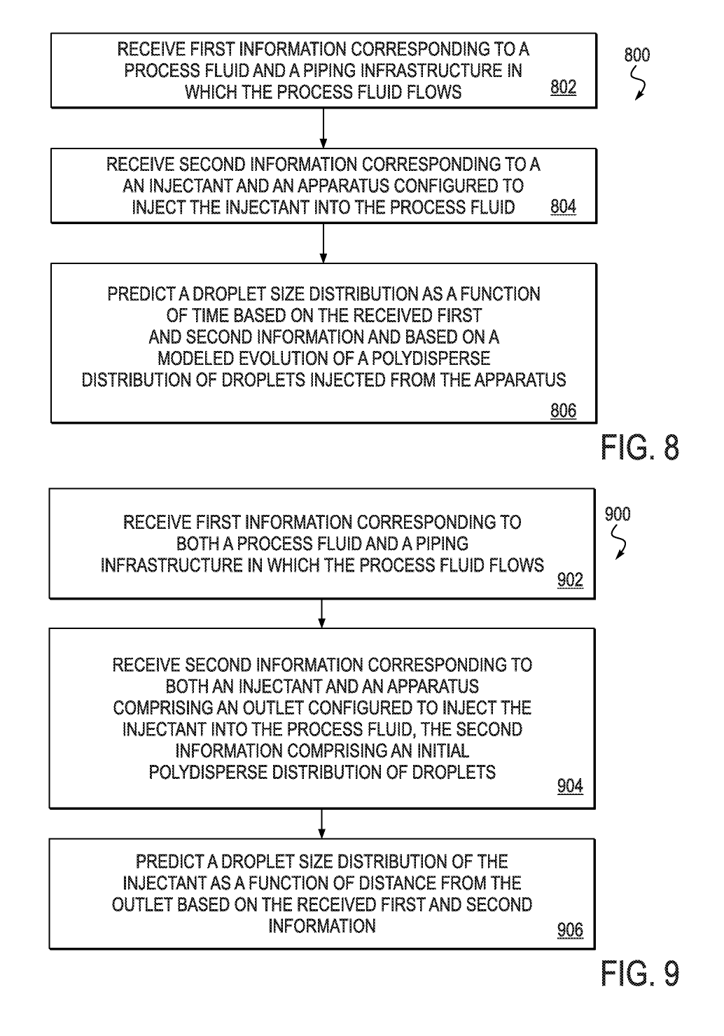

Having described certain embodiments of DPM systems 200, it should be appreciated, in the context of the present disclosure, that one embodiment of a method 800, illustrated in FIG. 8 and implemented by the processor 202 (or other processor) executing logic 206 of the DPM system 200, comprises receiving first information corresponding to a process fluid and a piping infrastructure in which the process fluid flows (802); receiving second information corresponding to an injectant and an injector configured to inject the injectant into the process fluid (804); and predicting a droplet size distribution as a function of time based on the received first and second information and based on a modeled evolution of a polydisperse distribution of droplets injected from the injector, the prediction based at least in part on computation of one or more closed-form expressions for droplet interaction processes (806). In other words, some embodiments may utilize a combination of closed-form expressions (e.g., in order to mathematically describe the kinetics of droplet collisions and coalescence, the kinetics of gravitational settling, and/or the diffusion of dispersed contaminant molecules to droplets in the scrubbing calculations) and numerical methods to describe the droplet population as it evolves with time. Further, it should be appreciated that certain embodiments of DPM systems 200 may use a much more limited scope of inputs compared to conventional systems, including parameters like pipe diameter, pipe length, and pipe surface roughness.

Another method embodiment 900, illustrated in FIG. 9 and implemented by the processor 202 (or other processor) executing logic 206 of the DPM system 200, comprises receiving first information corresponding to both a process fluid and a piping infrastructure in which the process fluid flows (902); receiving second information corresponding to both an injectant and an injector comprising an outlet configured to inject the injectant into the process fluid, the second information comprising an initial polydisperse distribution of droplets (904); and predicting a droplet size distribution of the injectant as a function of distance from the outlet based on the received first and second information, the prediction based at least in part on computation of one or more closed-form expressions for droplet interaction processes (906).

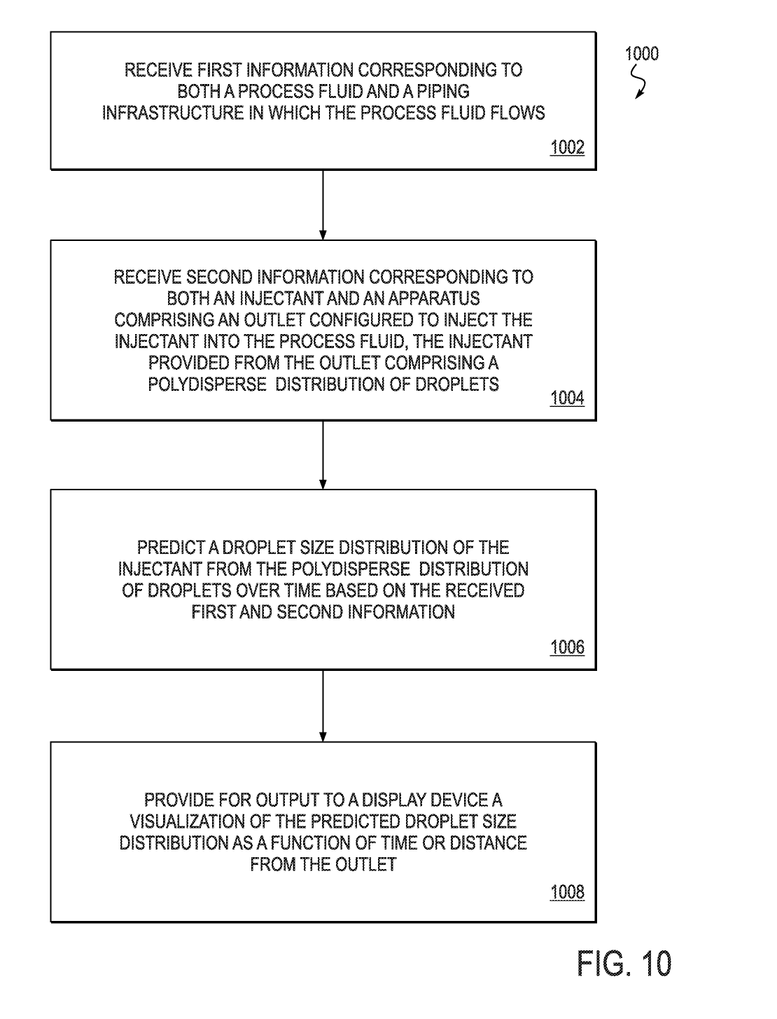

Another method embodiment 1000, illustrated in FIG. 10 and implemented by a processor 202 (or other processor) executing logic 206 of the DPM system 200 encoded on a computer readable medium, comprises receiving first information corresponding to both a process fluid and a piping infrastructure in which the process fluid flows (1002), receiving second information corresponding to both an injectant and an injector comprising an outlet configured to inject the injectant into the process fluid, the injectant provided from the outlet comprising a polydisperse distribution of droplets (1004), predicting a droplet size distribution of the injectant from the polydisperse distribution of droplets over time based on the received first and second information, the prediction based at least in part on computation of one or more closed-form expressions for droplet interaction processes (1006); and providing for output to a display device a visualization of the predicted droplet size distribution as a function of time or distance from the outlet (1008).

Any software components illustrated herein are abstractions chosen to illustrate how functionality is partitioned among components in some embodiments of the DPM systems disclosed herein. Other divisions of functionality are also possible, and these other possibilities are intended to be within the scope of this disclosure.

To the extent that systems and methods are described in object-oriented terms, there is no requirement that the systems and methods be implemented in an object-oriented. Any software components illustrated herein are abstractions chosen to illustrate how functionality is partitioned among components in some embodiments of the DPM systems disclosed herein. Other divisions of functionality are also possible, and these other possibilities are intended to be within the scope of this disclosure.

To the extent that systems and methods are described in object-oriented terms, there is no requirement that the systems and methods be implemented in an object-oriented language. Rather, the systems and methods can be implemented in any programming language, and executed on any hardware platform.

Any software components referred to herein include executable code that is packaged, for example, as a standalone executable file, a library, a shared library, a loadable module, a driver, or an assembly, as well as interpreted code that is packaged, for example, as a class.

The flow diagrams herein provide examples of the operation of the DPM systems and methods. Blocks in these diagrams represent procedures, functions, modules, or portions of code which include one or more executable instructions for implementing logical functions or steps in the process. Alternate implementations are also included within the scope of the disclosure. In these alternate implementations, functions may be executed out of order from that shown or discussed, including substantially concurrently or in reverse order, depending on the functionality involved.

The foregoing description of illustrated embodiments of the present disclosure, including what is described in the abstract, is not intended to be exhaustive or to limit the disclosure to the precise forms disclosed herein. While specific embodiments of, and examples for, the disclosure are described herein for illustrative purposes only, various equivalent modifications are possible within the spirit and scope of the present disclosure, as those skilled in the relevant art will recognize and appreciate. As indicated, these modifications may be made to the present disclosure in light of the foregoing description of illustrated embodiments.

Thus, while the present disclosure has been described herein with reference to particular embodiments thereof, a latitude of modification, various changes and substitutions are intended in the foregoing disclosures, and it will be appreciated that in some instances some features of embodiments of the disclosure will be employed without a corresponding use of other features without departing from the scope of the disclosure. Therefore, many modifications may be made to adapt a particular situation or material to the essential scope of the present disclosure. It is intended that the disclosure not be limited to the particular terms used in following claims and/or to the particular embodiment disclosed as the best mode contemplated for carrying out this disclosure, but that the disclosure will include any and all embodiments and equivalents falling within the scope of the appended claims.

1. A method for predicting the droplet size distribution of an injectant into a process fluid flowing in a piping infrastructure, comprising:
receiving first information corresponding to the process fluid and the piping infrastructure in which the process fluid flows;
receiving second information corresponding to the injectant and an injector configured to inject the injectant into the process fluid; and
predicting by a processor a droplet size distribution of the injectant over time based on the received first and second information, the prediction based at least in part on computation of one or more closed-form expressions for mathematical description of droplet interaction processes.

2. The method of claim 1, wherein the closed-form expressions correspond to one or more mathematical expressions for kinetics of droplet collisions and coalescence, and kinetics of gravitational settling.

3. The method of claim 1, wherein the first information corresponding to the piping infrastructure comprises characteristics of a process pipe of the piping infrastructure into which the injectant is injected from the injector.

4. The method of claim 2, wherein the characteristics of the of a process pipe comprise diameter, roughness, geometrical dimensions, quantity of hydraulic elements, and distance of hydraulic elements from the injector.

5. The method of claim 1, wherein the first information corresponding to the process fluid comprises density, viscosity, and flow rate of the process fluid.

6. The method of claim 1, wherein the second information corresponding to the injectant comprises flow rate of the injectant and initial droplet distribution output from the injector.

7. The method of claim 1, wherein the second information corresponding to the injector comprises characteristics of the injector.

8. The method of claim 6, wherein the characteristics comprise spray angle, spray patterns, number average diameter of droplets produced by the injector, Sauter average diameter of the droplets produced by the injector, and droplet velocity produced by the injector.

9. The method of claim 1, further comprising outputting a graphical representation of the predicted droplet size distribution as a function of distance.

10. The method of claim 1, wherein the injectant comprises an aqueous solution.

11. The method of claim 1, wherein the injector comprises an outlet from which the injectant flows into the process fluid and wherein the prediction of the droplet size distribution of the injectant is a function of distance from the outlet.

12. A system for predicting the droplet size distribution of an injectant into a process fluid in a piping infrastructure, comprising:
a memory with logic; and
a processor configured with the logic to:
receive first information corresponding to both the process fluid and the piping infrastructure in which the process fluid flows;
receive second information corresponding to both the injectant and an injector comprising an outlet configured to inject the injectant into the process fluid, the second information comprising an initial polydisperse distribution of droplets; and
predict a droplet size distribution of the injectant as a function of distance from the outlet based on the received first and second information, the prediction based at least in part on computation of one or more closed-form expressions for droplet interaction processes.

13. The system of claim 12, wherein the first information comprises:
characteristics of a process pipe of the piping infrastructure in which the injectant flows, wherein the characteristics comprise diameter, roughness, geometrical dimensions, quantity of hydraulic elements, and distance of the hydraulic elements from the injector; and
density, viscosity, and flow rate of the process fluid.

14. The system of claim 12, wherein the second information comprises:
flow rate of the injectant; and
characteristics of the injector, wherein the characteristics comprise spray angle, spray patterns, number average diameter of droplets produced by the injector, Sauter average diameter of the droplets produced by the injector, and droplet velocity produced by the injector.

15. The system of claim 12, wherein the processor is further configured by the logic to model changes in the scrubbing efficiency when an amount of the injectant impinges on a wall of a process pipe of the piping infrastructure, the impingement occurring in an immediate vicinity of a location in which the injectant is introduced from the injector to the process fluid.

16. The system of claim 12, wherein the processor is further configured by the logic to model changes in the scrubbing efficiency when an amount of the injectant that settles in a process pipe of the piping infrastructure as a function of distance from a location in which the injectant is introduced from the injector to the process fluid.

17. The system of claim 12, wherein the processor is further configured by logic to provide a graphics user interface configured with fields corresponding to at least a portion of the first and second information and provide an output graphic corresponding to the predicted droplet size distribution and concentration of the injectant.

18. The system of claim 12, wherein the closed-form expressions correspond to one or more expressions for mathematical description of kinetics of droplet collisions and coalescence, and kinetics of gravitational settling.

19. A computer readable medium encoded with software code that is executed by a processor to cause the processor to:
receive first information corresponding to both a process fluid and a piping infrastructure in which the process fluid flows;
receive second information corresponding to both an injectant and an injector comprising an outlet configured to inject the injectant into the process fluid, the second information comprising an initial polydisperse distribution of droplets;
predict a droplet size distribution of the injectant over time based on the received first and second information, the prediction based at least in part on computation of one or more closed-form expressions for droplet interaction processes; and
provide for output to a display device a visualization of the injectant concentration as a function of distance along a pipeline as well as the predicted droplet size distribution as a function of time or distance from the outlet.

20. The computer readable medium of claim 19, wherein
the first information comprises: characteristics of a process pipe of the piping infrastructure in which the injectant flows, wherein the characteristics comprise diameter, roughness, geometrical dimensions, quantity of hydraulic elements, and distance of the hydraulic elements from the injector; and density, viscosity, and flow rate of the process fluid; and
the second information comprises: flow rate of the injectant; and characteristics of the injector, wherein the characteristics comprise spray angle, spray patterns, number average diameter of droplets produced by the injector, Sauter average diameter of the droplets produced by the injector, and droplet velocity produced by the injector.
